(19) United States
(12) Patent Application Publication
(10) Pub. No.: US 2003/0036402 A1
(43) Pub. Date: Feb. 20, 2003

(54) Cellular broadcast receiver

(76) Inventor: Brett J. Gelsomino, West Palm Beach, FL (US)

Correspondence Address: WEISS & MOY PC, 4204 NORTH BROWN AVENUE, SCOTTSDALE, AZ, 85251, US

(21) Appl. No.: 09/933,083

(22) Filed: Aug. 20, 2001

(51) Int. Cl. H04B 7/00

(52) U.S. Cl. 455/517; 455/45; 455/161.3; 455/186.1

(57) ABSTRACT

A cellular broadcast receiver and method for continuous reception of broadcasted audio signals for a selected genre in a motor vehicle independent of the broadcasting area of a specific broadcast channel, comprising, in combination, a cellular modem/computer processor unit, a control unit, and a sound processor.

In a preferred embodiment the cellular broadcast receiver is able to communicate with a cellular tower. In another preferred embodiment the cellular broadcast receiver is able to receive and decode a genre code transmitted together with the audio signal from a broadcast station.

### BACKGROUND OF THE INVENTION

1. Field of the Invention

This invention relates generally to electronic audio entertainment devices and, more specifically, to a cellular broadcast receiver and a method for continuously receiving a broadcasted audio signal for a selected genre.

2. Description of the Prior Art

The prior art includes various electronic audio entertainment devices. Nearly every motor vehicle is equipped with an audio system such as a radio, a cassette tape player, a CD player, or combinations thereof. Listening to a radio station of the preferred genre can be interrupted while driving long distances caused by leaving the broadcasting area of the selected radio station. Finding a different radio station playing your favorite genre involves pressing several buttons of the radio control unit. This process is time consuming and distracts from paying attention to the traffic and from driving the vehicle. Furthermore, some areas may not have the genre that the driver/passenger desires.

An increasing number of motor vehicles are being equipped with mobile communication devices such as cellular phones. Cellular phones communicate with cellular towers such that the communication is continuous while moving from one cellular area to another as long as there are cellular towers in the general vicinity.

Prior art discloses the combination of audio entertainment systems and mobile communication systems. For example, U.S. Pat. No. 5,991,637 issued to Mack, II, et al., U.S. Pat. No. 5,243,640 issued to Hadley, et al., and U.S. Pat. No. 5,978,689 issued to Tuoriniemi, et al., all utilize a mobile communication system and a audio entertainment system combining features of both systems in one device. Other applications, for example U.S. Pat. No. 6,160.997 issued to Oberlaender and U.S. Pat. No. 5,781,850 issued to Ugge' et al., include controlling both the audio entertainment system and the mobile communication system with the same unit. This unit is preferably a multifunctional keypad or a live voice device. In another case, for example U.S. Pat. No. 5,905,947 issued to Stein, the electronic audio entertainment system of a motor vehicle is modified to be capable of communicating data signals over wireless networks.

However, these devices do not change the way the audio entertainment system functions in a motor vehicle. When leaving the broadcasting area of a selected channel which carries the preferred genre, the reception level of the selected channel will diminish and will finally fall below the noise level in the vehicle as the vehicle is too far away as to receive the radio signal. Subsequently, the driver or a passenger of the motor vehicle has to search for another station playing the preferred genre with an acceptable reception level. This process is time consuming, distracts from paying attention to the traffic and from driving the vehicle and creates potential traffic hazards. Furthermore, certain areas of the country may not have a desire genre.

Therefore a need existed to provide a device which delivers an uninterrupted reception of a broadcasted audio signal for a selected genre independent of the broadcasting area of a specific radio station. A further need existed to provide a method for uninterrupted reception of a broadcasted audio signal for a selected genre independent of the broadcasting area of a specific radio station.

### SUMMARY OF THE INVENTION

An object of the present invention is to provide a cellular broadcast receiver.

It is a further object of the present invention to provide a cellular broadcast receiver that is able to provide an uninterrupted reception of a broadcasted audio signal for a selected genre independent of the broadcasting area of a specific radio station.

It is a still further object of the present invention to provide a cellular broadcast receiver that can be connected to a standard audio entertainment system in a motor vehicle.

It is a still further object of the present invention to provide a method for uninterrupted reception of a broadcasted audio signal for a selected genre independent of the broadcasting area of a specific radio station.

### BRIEF DESCRIPTION OF THE PREFERRED EMBODIMENTS

In accordance with one embodiment of the present invention, a first cellular broadcast receiver is disclosed which comprises, in combination: a cellular modem/computer processor unit, a control unit, and a sound processor.

In accordance with another embodiment of the present invention, a first method for continuous reception of broadcasted audio signals for a selected genre in a motor vehicle independent of the broadcasting area of a specific broadcast channel is disclosed.

In accordance with another embodiment of the present invention, a second cellular broadcast receiver is disclosed which comprises, in combination: a computer processor unit, a control unit, and a sound processor.

In accordance with another embodiment of the present invention, a second method for continuous reception of broadcasted audio signals for a selected genre in a motor vehicle independent of the broadcasting area of a specific broadcast channel is disclosed.

The foregoing and other objects, features, and advantages of the invention will be apparent from the following, more particular, description of the preferred embodiments of the invention, as illustrated in the accompanying drawings.

### BRIEF DESCRIPTION OF THE DRAWINGS

FIG. 1 is a block diagram of a first cellular broadcast receiver.

FIG. 2 is a simplified flow chart illustrating a method for using the first cellular broadcast receiver.

FIG. 3 is a block diagram of a second cellular broadcast receiver.

FIG. 4 is a simplified flow chart illustrating a method for using the second cellular broadcast receiver.

### DETAILED DESCRIPTION OF THE PREFERRED EMBODIMENTS

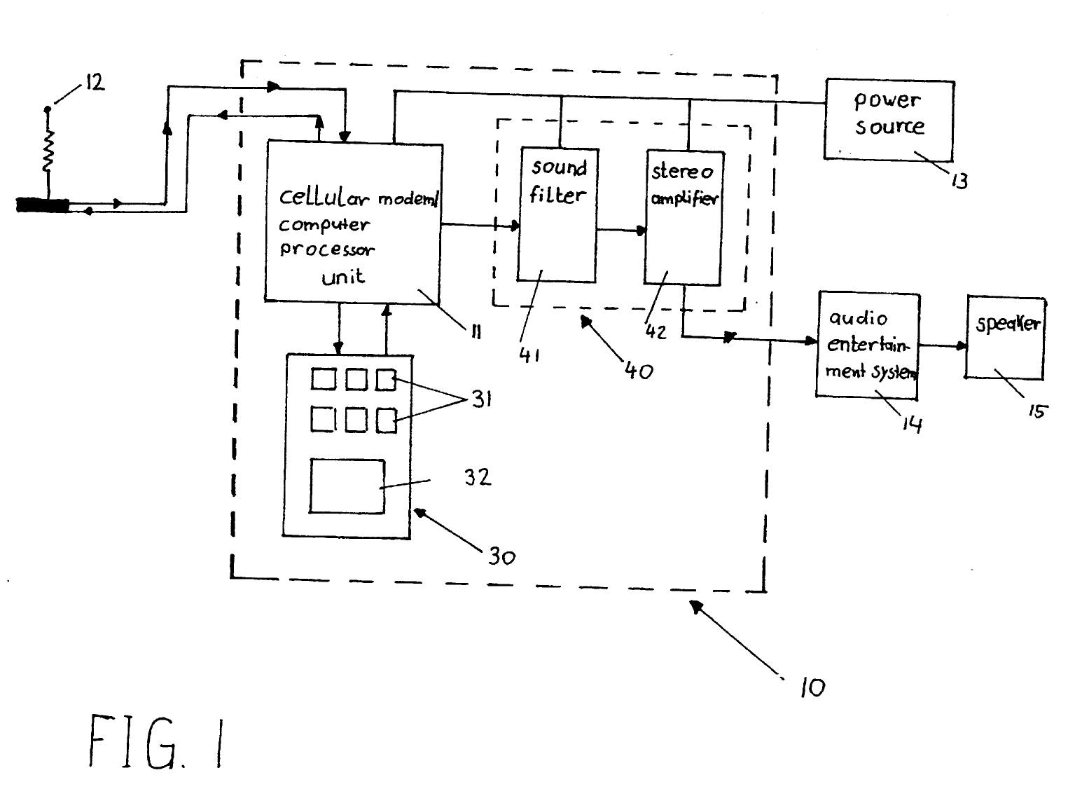

Referring to FIG. 1, a block diagram of one embodiment of a cellular broadcast receiver 10 according to the present invention is shown. The cellular broadcast receiver 10 generally comprises a cellular modem/computer processor unit 11, a control unit 30, and a sound processor 40. The control unit 30 comprises several keys 31 and a display 32, preferably a LCD display. The sound processor 40 comprises a sound filter 41 and a stereo amplifier 42. The cellular broadcast receiver 10 is preferably connected to a standard audio entertainment system 14, a power source 13, and an antenna 12 of a motor vehicle. The standard audio entertainment system 14 includes speakers 15. The control unit 30 allows the user to input simple commands, including the genre selection, using the keys 31 and the display 32. The antenna 12 is used for sending and receiving signals to or from a cellular tower. The power source 13 is preferably a 12 V standard power source of a motor vehicle.

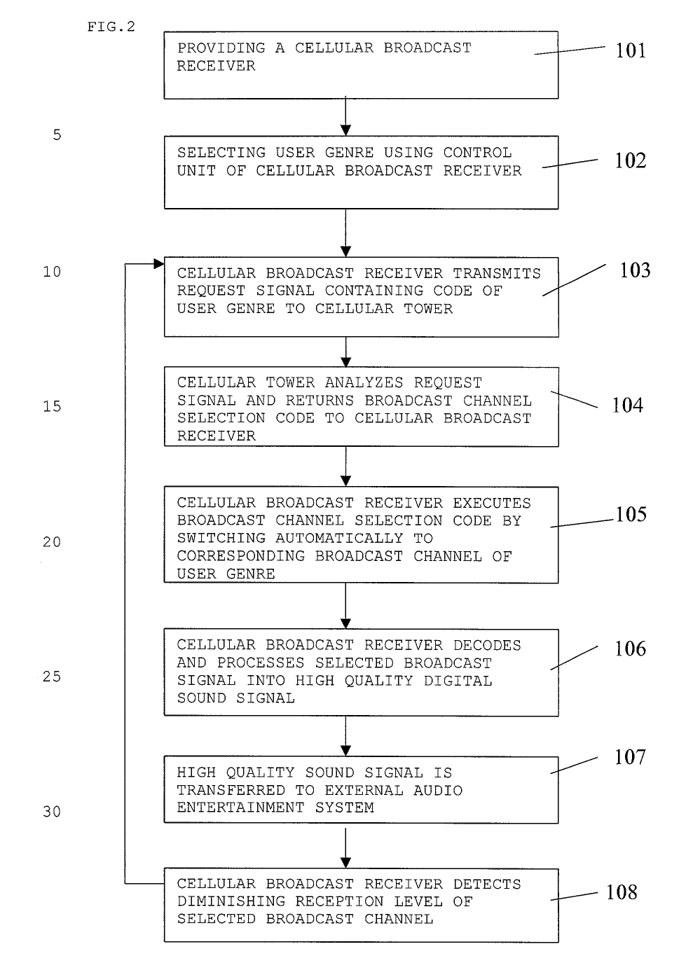

Now referring to FIG. 2, a simplified flow chart illustrating a method for using the first cellular broadcast receiver 10 is shown. In step 101, a cellular broadcast receiver 10 according to the present invention is provided. In step 102, the user selects a genre using the keys 31 and the display 32 of control unit 30. The entered commands are fed into the cellular modem/computer processor unit 11 of the cellular broadcast receiver 10. In step 103, the cellular modem/computer processor unit 11 analyzes the user commands and transmits a request signal containing the code of the user genre to a cellular tower to initiate the broadcast channel selection process. In step 104, the cellular tower analyses the request signal and returns a broadcast channel selection code to the modem/computer processor unit 11. In step 105, the modem/computer processor unit 11 of the cellular broadcast receiver 10 executes the broadcast channel selection code by switching automatically to the corresponding broadcast channel of the requested user genre. The name of the selected broadcast channel will be displayed on the display 32 of the control unit 30. In step 106, the modem/computer processor unit 11 decodes the incoming signal of the selected broadcast channel into a digital audio signal. This raw audio signal is transferred to the sound processor 40. The sound filter 41 of the sound processor 40 enhances the sound quality by removing static noise and starts the Digital Sound Processing (DSP). The stereo amplifier 42 of the sound processor 40 then formats the sound to Dolby Surround Sound. In step 107, the Dolby quality sound signal is transferred to an external standard audio entertainment system 14 and can be listened to over the speakers 15 thereof. In step 108, the cellular modem/computer processor unit 11 of the cellular broadcast receiver 10 detects a diminishing reception level of the selected broadcast channel and sends a next request signal containing the code of the user genre to the cellular tower to initiate the next broadcast channel selection process, as illustrated in the flow chart of FIG. 2.

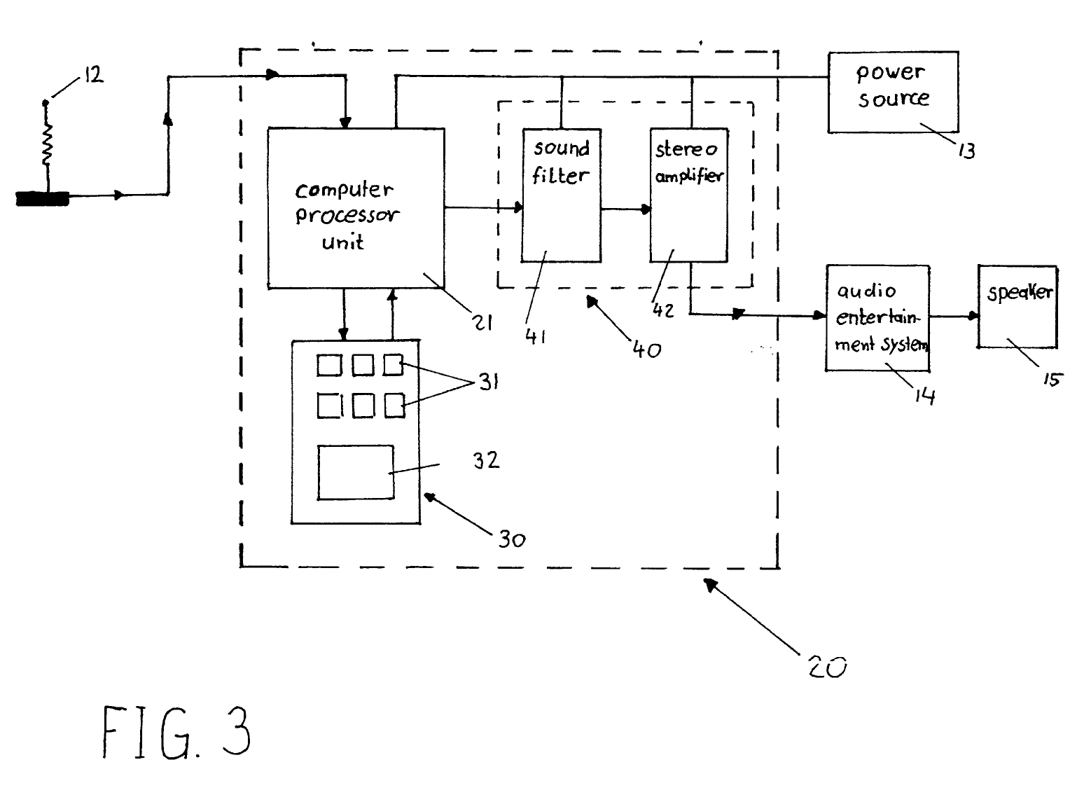

Now referring to FIG. 3 a block diagram of a second cellular broadcast receiver 20 according to the present invention is shown. The cellular broadcast receiver 20 generally comprises a computer processor unit 21, a control unit 30, and a sound processor 40. The control unit 30 comprises several keys 31 and a display 32, preferably a LCD display. The sound processor 40 comprises a sound filter 41 and a stereo amplifier 42. The cellular broadcast receiver 20 is preferably connected to standard audio entertainment system 14, a power source 13, and an antenna 12 of a motor vehicle. The standard audio entertainment system 14 includes speakers 15. The control unit 30 allows the user to input simple commands, including the genre selection, using the keys 31 and the display 32. Antenna 12 is used for receiving signals from a broadcast station. The power source 13 is preferably a 12 V standard power source of a motor vehicle.

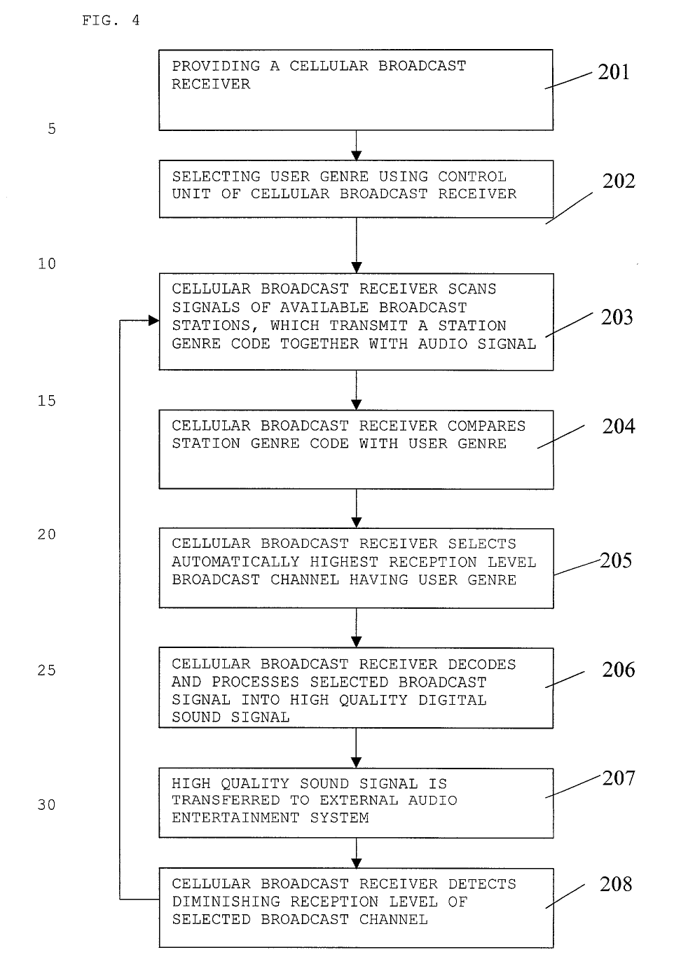

Now referring to FIG. 4, a simplified flow chart illustrating a method for using the second cellular broadcast receiver 20 is shown. In step 201, a cellular broadcast receiver 20 according to the present invention is provided. In step 202, the user selects a genre using the keys 31 and the display 32 of control unit 30. The entered commands are fed into the computer processor unit 21 of the cellular broadcast receiver 20. In step 203, the computer processor unit 21 scans the signals of available broadcast stations, which transmit a station genre code together with the audio signal. In step 204, the computer processor unit 21 compares the station genre codes with the user selected genre code, and subsequently, in step 205, selects automatically the highest reception level broadcast channel having user genre. The name of the selected broadcast channel will be displayed on the display 32 of the control unit 30. In step 206, the computer processor unit 21 decodes the incoming signal of the selected broadcast channel into a digital audio signal. This raw audio signal is transferred to the sound processor 40. The sound filter 41 of the sound processor 40 enhances the sound quality by removing static noise and starts the Digital Sound Processing (DSP). The stereo amplifier 42 of the sound processor 40 then formats the sound to Dolby Surround Sound. In step 207, the Dolby quality sound signal is transferred to an external standard audio entertainment system 14 and can be listened to over the speakers 15 thereof. In step 108, the computer processor unit 21 of the cellular broadcast receiver 20 detects a diminishing reception level of the selected broadcast channel and scans the signals of available broadcast stations, which transmit a station genre code together with the audio signal, to initiate the next broadcast channel selection process, as indicated in the flow chart of FIG. 4.

Both the cellular broadcast receiver 10 and 20 realize continuous reception of broadcasted signals for a selected genre independent of the broadcasting area of a specific channel. By connecting to a standard audio system installed in a motor vehicle, and using the 12V power source of a motor vehicle as well as the antenna thereof, the cellular broadcast receiver of the present invention is relatively practical and inexpensive.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A first cellular broadcast receiver comprising, in combination:
a cellular modem/computer processor unit;
a control unit, including keys and a display; and
a sound processor, including a sound filter and a stereo amplifier.

2. The first cellular broadcast receiver of claim 1, wherein said cellular modem/computer processor unit is able to communicate with a cellular tower.

3. The first cellular broadcast receiver of claim 1, being connected to standard audio entertainment system, a 12 V power source, and an antenna of a motor vehicle.

4. A method for continuous reception of broadcasted audio signals for a selected genre in a motor vehicle independent of the broadcasting area of a specific broadcast channel, comprising, in combination, the steps of:
providing said first cellular broadcast receiver;
selecting a user genre using the control unit of said first cellular broadcast receiver;
transmitting a request signal containing the code of said user genre to a cellular tower with said first cellular broadcast receiver to initiate a broadcast channel selection process;
receiving a broadcast channel selection code from said cellular tower, after said request signal was analyzed by said cellular tower, with said first cellular broadcast receiver;
executing said broadcast channel selection code by switching automatically to the corresponding broadcast channel of said user genre with said first cellular broadcast receiver;
decoding and processing incoming signal of said broadcast channel into a high quality sound signal with said first cellular broadcast receiver;
transferring said high quality sound signal to an external audio entertainment system from said first cellular broadcast receiver;
detecting diminishing reception level of said broadcast channel with said first cellular broadcast receiver; and
sending a next request signal containing said code of said user genre to a cellular tower with said first cellular broadcast receiver to initiate the next said broadcast channel selection process.

5. A second cellular broadcast receiver comprising, in combination:
a computer processor unit;
a control unit, including keys and a display; and
a sound processor, including a sound filter and a stereo amplifier.

6. The second cellular broadcast receiver of claim 5, wherein said computer processor unit is able to receive and decode a genre code transmitted together with the audio broadcast signal from broadcast stations.

7. The second cellular broadcast receiver of claim 5, being connected to standard audio entertainment system, a 12 V power source, and an antenna of a motor vehicle.

8. A method for continuous reception of broadcasted audio signals for a selected genre in a motor vehicle independent of the broadcasting area of a specific broadcast channel, comprising, in combination, the steps of:
providing a second cellular broadcast receiver;
selecting a user genre using the control unit of said second cellular broadcast receiver;
scanning signals of available broadcast stations which transmit a station genre code together with an audio signal, with said second cellular broadcast receiver;
initiating a broadcast channel selection process by comparing said station genre codes with said user genre;
selecting automatically the highest reception level broadcast channel having said user genre with said second cellular broadcast receiver;
decoding and processing incoming signal of said selected broadcast channel into a high quality sound signal with said second cellular broadcast receiver;
transferring said high quality sound signal to an external audio entertainment system from said second cellular broadcast receiver;
detecting diminishing reception level of said selected broadcast channel with said second cellular broadcast receiver;
scanning said signals of available broadcast stations which transmit said station genre code together with said audio signal, with said second cellular broadcast receiver to initiate a next said broadcast channel selection process.
